(19) United States
(12) Patent Application Publication
(10) Pub. No.: US 2006/0151618 A1
(43) Pub. Date: Jul. 13, 2006

(54) Multi-chip devices, circuits, methods, and computer program products for reading programmed device information therein

(76) Inventor: Ki-Rock Kwon, Gyeonggi (KR)

Correspondence Address: MYERS BIGEL SIBLEY & SAJOVEC, PO BOX 37428, RALEIGH, NC, 27627, US

(21) Appl. No.: 11/259,612

(22) Filed: Oct. 26, 2005

(30) Foreign Application Priority Data
Jan. 12, 2005 (KR) 10-2005-0002876

(51) Int. Cl. G06K 19/06

(52) U.S. Cl. 235/492

(57) ABSTRACT

A signature identification circuit of a semiconductor chip can include a resistor connected to a power supply voltage, a first fuse connected in series with the resistor, first, second, and third transistors connected in series with one another and with the first fuse, second, third, and fourth fuses connected in parallel with the first, second, and third transistors, respectively, a fourth transistor connected in series with the third transistor, and a fifth transistor having a first terminal connected to the fourth transistor, a second terminal connected to an address signal, and a third terminal connected to an external control signal, separate from the address signal.

### CROSS-REFERENCE TO RELATED PATENT APPLICATION

This application claims the benefit of Korean Patent Application No. 10-2005-0002876, filed on Jan. 12, 2005, in the Korean Intellectual Property Office, the disclosure of which is incorporated herein in its entirety by reference.

### FIELD OF THE INVENTION

The present invention relates to a semiconductor apparatus, and more particularly, to a system for reading signature identification information in a multi-chip device (MCP).

BACKGROUND

A semiconductor apparatus mounted with a plurality of semiconductor chips is sometimes referred to as a multi-chip package (MCP) or device. As for a MCP, semiconductor chips may be built in a single package at high density in order to realize miniaturization or high-speed operation. A semiconductor chip may have associated unique signature identification information. The signature identification information of a semiconductor chip is device information including, for example, a manufacturer code, a manufacturer lot number, wafer coordinates, and a mask set. A semiconductor chip includes a signature identification system (i.e., circuit) to store such device information.

FIG. 1 illustrates a conventional MCP 100 including a signature identification system. The MCP 100 includes two semiconductor chips, i.e., first and second semiconductor chips which may be flash memory chips. A signature identification system 110 in the first chip includes a resistor 111, a first fuse 112, and first through fourth transistors 113, 114, 115, and 116, which are connected in series between a power supply voltage Vcc and an address signal Addr. A second fuse 117 is connected in parallel with the first transistor 113 as shown. A third fuse 118 is connected in parallel with the second transistor 114. A fourth fuse 119 is connected in parallel with the third transistor 115 as shown. A signature identification system 120 in the second chip has the same structure as the signature identification system 110 in the first chip. The signature identification system 110 in the first chip and the signature identification system 120 in the second chip share the power supply voltage Vcc and the address signal Addr. The two signature identification systems 110 and 120 are provided for each address signal Addr.

The signature identification system 110 in the first chip stores device information of the first chip according to programming (cutoff or non-cutoff) of the second through fourth fuses 117 through 119. When a predetermined current flows via the address signal Addr, a voltage level across the signature identification system 110 changes due to the change in the resistance offered by components within the signature identification system 110 according to programming of the second through fourth fuses 117 through 119. Therefore, the signature identification system 110 can provide the device information of the first chip based on the voltage level provided.

### SUMMARY

Embodiments according to the invention can provide multi-chip devices, circuits, methods, and computer program products for reading programmed device information therein. Pursuant to these embodiments, a signature identification circuit of a semiconductor chip can include a resistor connected to a power supply voltage, a first fuse connected in series with the resistor, first, second, and third transistors connected in series with one another and with the first fuse, second, third, and fourth fuses connected in parallel with the first, second, and third transistors, respectively, a fourth transistor connected in series with the third transistor, and a fifth transistor having a first terminal connected to the fourth transistor, a second terminal connected to an address signal, and a third terminal connected to an external control signal, separate from the address signal.

In some embodiments according to the invention, the semiconductor chip includes a plurality of signature identification circuit connected between the power supply voltage and a plurality of address signals according to device information programmed into the semiconductor chip. In some embodiments according to the invention, the external control signal is a chip selection signal for the semiconductor chip. In some embodiments according to the invention, the external control signal is a mode setting signal for the semiconductor chip. In some embodiments according to the invention, the second through fourth fuses are selectively cut according to device information programmed into the semiconductor chip.

In some embodiments according to the invention, each of the first through fourth transistors includes a source terminal and a gate terminal connected to each other to provide a diode configuration thereof. In some embodiments according to the invention, a multi-chip device including a plurality of semiconductor chips therein, the multi-chip device includes a first semiconductor chip, a second semiconductor chip, a first signature identification circuit associated with the first semiconductor chip, and connected between a power supply voltage and an address signal, configured to operate responsive to a first external control signal that is separate from the address signal, and a second signature identification circuit associated with the second semiconductor chip, and connected between the power supply voltage and the address signal, configured to operate responsive to a second external control signal that is separate from the address signal and the first external control signal. In some embodiments according to the invention, each of the first through fourth transistors includes a source terminal and a gate terminal connected to each other to provide a diode configuration thereof.

In some embodiments according to the invention, a method of operating a multi-chip device including a plurality of separate signature identification circuits, includes enabling a first signature identification circuit responsive to a first external control signal provided thereto, providing a first current signal to the first signature identification circuit via an address signal, and providing a first voltage signal across the first signature identification circuit responsive to the first external control signal and the first current signal based on states associated with first fuses indicating information programmed into the first signature identification.

In some embodiments according to the invention, the method further includes enabling a second signature identification circuit responsive to a second external control signal provided thereto that is separate from the first external control signal, providing a second current signal to the second signature identification circuit via the address signal, and providing a second voltage signal across the second signature identification circuit responsive to the second external control signal and the second current based on states associated with second fuses indicating information programmed into the first signature identification.

In some embodiments according to the invention, enabling a second signature identification circuit further includes enabling the second signature identification circuit responsive to the second external control signal at a time when the first external control signal disables operation of the first signature identification circuit.

In some embodiments according to the invention, a computer program product includes a computer readable medium having computer readable program code embodied therein, wherein the computer readable program code is configured to operate according to the method.

### BRIEF DESCRIPTION OF THE DRAWINGS

FIG. 1 illustrates a conventional multi-chip device (MCP) including a signature identification system.

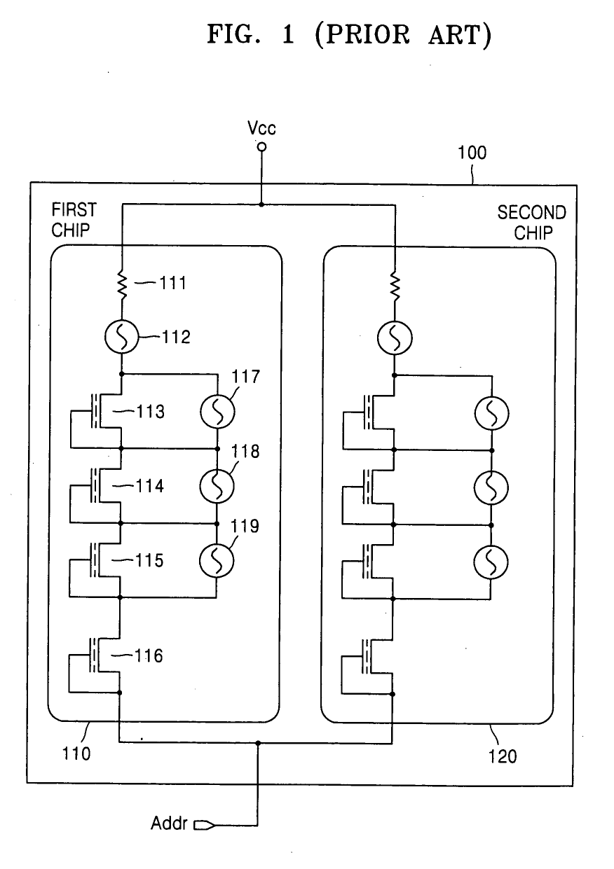

FIG. 2 illustrates a MCP including a signature identification system according to an embodiment of the present invention.

FIG. 3 is a flowchart illustrating operations of an MCP including a signature identification system in some embodiments according to the invention.

### DESCRIPTION OF EMBODIMENTS ACCORDING TO THE INVENTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first portion could be termed a second portion, and, similarly, a second portion could be termed a first portion without departing from the teachings of the disclosure.

As will be appreciated by one of skill in the art, the present invention may be embodied as methods, systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The present invention is described below with reference to circuit schematics and flowchart illustrations of methods, circuits, systems and computer program products according to embodiments of the invention. It is understood that each block in the illustrations can be implemented (wholly or partially) by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the blocks.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

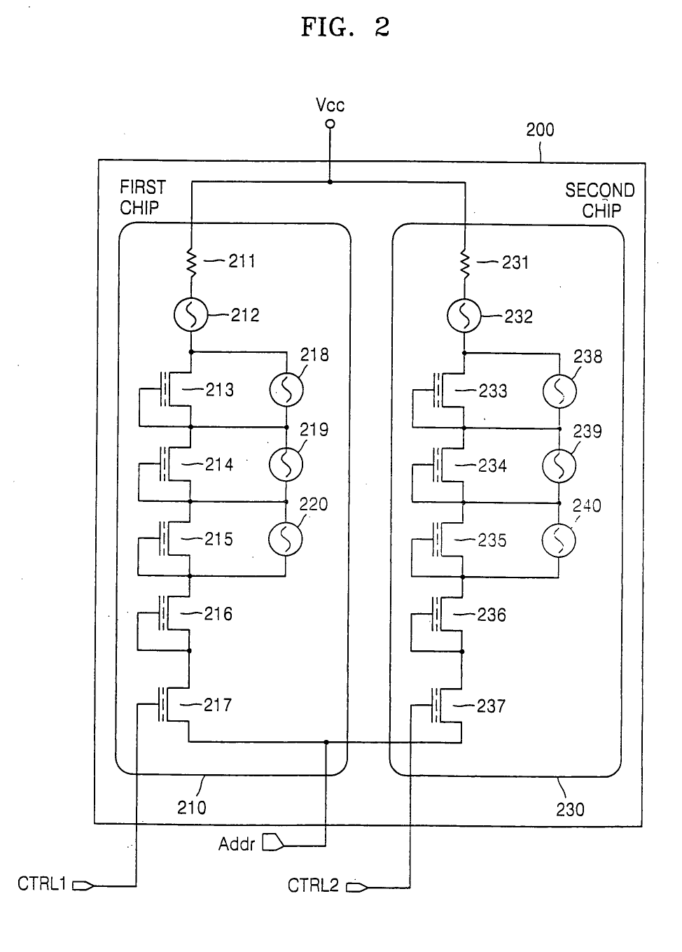

FIG. 2 illustrates a multi-chip device (MCP) 200 including a signature identification system according to an embodiment of the present invention. The MCP 200 includes a first chip and a second chip and may further include a plurality of chips. For clarity of the description, the MCP 200 is assumed to include two chips which may be homogeneous or heterogeneous.

A first signature identification system 210 in the first chip includes a resistor 211, a first fuse 212, and first through fifth transistors 213, 214, 215, 216, and 217, which are connected in series between a power supply voltage Vcc and an address signal Addr. A second fuse 218 is connected to both ends of the first transistor 213. A third fuse 219 is connected to both ends of the second transistor 214. A fourth fuse 220 is connected to both ends of the third transistor 215. Each of the first through fourth transistors 213 through 216 has a gate and a source which are connected to each other, thereby forming a diode structure. The fifth transistor 217 has a gate connected to a first control signal CTRL1, which is provided from the outside of the MCP 200. For example, the first control signal CTRL1 may be a first chip select signal CS1 or a mode setting signal MRS1. The second through fourth fuses 218 through 220 are selectively cut according to the device information of the first chip.

A second signature identification system 230 in the second chip includes a resistor 231, a first fuse 232, and first through fifth transistors 233, 234, 235, 236, and 237, which are connected in series between the power supply voltage Vcc and the address signal Addr. A second fuse 238 is connected to both ends of the first transistor 233. A third fuse 239 is connected to both ends of the second transistor 234. A fourth fuse 240 is connected to both ends of the third transistor 235. Each of the first through fourth transistors 233 through 236 has a gate and a source which are connected to each other, thereby forming a diode structure. The fifth transistor 237 has a gate connected to a second control signal CTRL2, which is provided from the outside of the MCP 200. For example, the second control signal CTRL2 may be a second chip select signal CS2 or a mode setting signal MRS2. The second through fourth fuses 238 through 240 are selectively cut according to the device information of the second chip.

The first signature identification system 210 in the first chip and the second signature identification system 230 in the second chip are separately enabled by the first control signal CTRL1 and the second control signal CTRL2, respectively. The first and second signature identification systems 210 and 230 share the power supply voltage Vcc and the address signal Addr are connected to each address signal in order to provide various types of device information.

As appreciated by the present inventors, it may not be easy to read the device information of individual chips in an MCP if the signature identification systems associated with the chips therein share the power supply voltage Vcc and the address signal Addr.

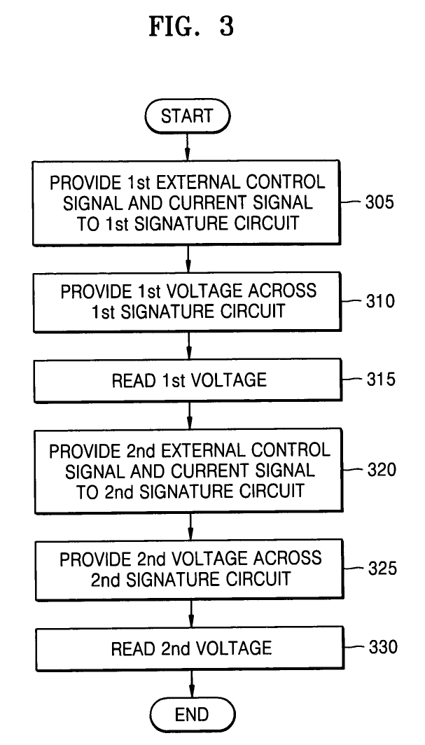

The following description concerns the operations of the first and second signature identification systems 210 and 230 in reference to FIG. 3. When the first control signal CTRL1 is activated and a predetermined current is applied to an address signal terminal (block 305), a predetermined voltage is generated at both ends of the first signature identification system 210 (block 310). Then, the first signature identification system 210 reads the device information of the first chip by detecting a voltage level at both ends thereof (block 315). When the second control signal CTRL2 is activated and the predetermined current is applied to the address signal terminal (block 320), a predetermined voltage is generated at both ends of the second signature identification system 230 (block 325). Then, the second signature identification system 230 reads the device information of the second chip by detecting a voltage level at both ends thereof (block 330). Here, it is preferable that the first control signal CTRL1 and the second control signal CTRL2 are not activated simultaneously.

As described above, in a MCP including signature identification systems according to embodiments of the present invention, the device information of each chip can be selectively read in response to a control signal corresponding to the chip.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed:

1. A signature identification circuit of a semiconductor chip, comprising:
a resistor connected to a power supply voltage;
a first fuse connected in series with the resistor;
first, second, and third transistors connected in series with one another and with the first fuse;
second, third, and fourth fuses connected in parallel with the first, second, and third transistors, respectively;
a fourth transistor connected in series with the third transistor; and
a fifth transistor having a first terminal connected to the fourth transistor, a second terminal connected to an address signal, and a third terminal connected to an external control signal, separate from the address signal.

2. The signature identification circuit of claim 1 wherein the semiconductor chip comprises a plurality of signature identification circuits connected between the power supply voltage and a plurality of address signals according to device information programmed into the semiconductor chip.

3. The signature identification circuit of claim 1 wherein the external control signal comprises a chip selection signal for the semiconductor chip.

4. The signature identification circuit of claim 1 wherein the external control signal comprises a mode setting signal for the semiconductor chip.

5. The signature identification circuit of claim 1 wherein the second through fourth fuses are selectively cut according to device information programmed into the semiconductor chip.

6. The signature identification circuit of claim 1 wherein each of the first through fourth transistors comprises a source terminal and a gate terminal connected to each other to provide a diode configuration thereof.

7. A multi-chip device including a plurality of semiconductor chips therein, the multi-chip device comprising:
a first semiconductor chip;
a second semiconductor chip;
a first signature identification circuit associated with the first semiconductor chip, and connected between a power supply voltage and an address signal, configured to operate responsive to a first external control signal that is separate from the address signal; and
a second signature identification circuit associated with the second semiconductor chip, and connected between the power supply voltage and the address signal, configured to operate responsive to a second external control signal that is separate from the address signal and the first external control signal.

8. The multi-chip device of claim 7 wherein the first external control signal comprises a chip select signal configured to enable the first semiconductor chip for operation responsive to a current provided thereto via the address signal.

9. The multi-chip device of claim 7 wherein the first external control signal comprises a mode setting signal configured to enable the first semiconductor chip for operation responsive to a current provided thereto via the address signal.

10. The multi-chip device of claim 7 wherein the second external control signal comprises a chip select signal configured to enable the second semiconductor chip for operation responsive to a current provided thereto via the address signal.

11. The multi-chip device of claim 7 wherein the second external control signal comprises a mode setting signal configured to enable the second semiconductor chip for operation responsive to a current provided thereto via the address signal.

12. The multi-chip device of claim 7 wherein the first signature identification circuit comprises:
a resistor connected to a power supply voltage;
a first fuse connected in series with the resistor;
first, second, and third transistors connected in series with one another and with the first fuse;
second, third, and fourth fuses connected in parallel with the first, second, and third transistors, respectively;
a fourth transistor connected in series with the third transistor; and
a fifth transistor having a first terminal connected to the fourth transistor, a second terminal connected to the address signal, and a third terminal connected to the first external control signal.

13. The multi-chip device of claim 12 wherein the second through fourth fuses are selectively cut according to device information programmed into the first semiconductor chip.

14. The multi-chip device of claim 12 wherein each of the first through fourth transistors comprises a source terminal and a gate terminal connected to each other to provide a diode configuration thereof.

15. The multi-chip device of claim 7 wherein the second signature identification circuit comprises:
a resistor connected to a power supply voltage;
a first fuse connected in series with the resistor;
first, second, and third transistors connected in series with one another and with the first fuse;
second, third, and fourth fuses connected in parallel with the first, second, and third transistors, respectively;
a fourth transistor connected in series with the third transistor; and
a fifth transistor having a first terminal connected to the fourth transistor, a second terminal connected to the address signal, and a third terminal connected to the second external control signal.

16. The multi-chip device of claim 15 wherein the second through fourth fuses are selectively cut according to device information programmed into the second semiconductor chip.

17. The multi-chip device of claim 15 wherein each of the first through fourth transistors comprises a source terminal and a gate terminal connected to each other to provide a diode configuration thereof.

18. A method of operating a multi-chip device including a plurality of separate signature identification circuits, the method comprising:
enabling a first signature identification circuit responsive to a first external control signal provided thereto;
providing a first current signal to the first signature identification circuit via an address signal; and
providing a first voltage signal across the first signature identification circuit responsive to the first external control signal and the first current signal based on states associated with first fuses indicating information programmed into the first signature identification.

19. A method according to claim 18 further comprising:
enabling a second signature identification circuit responsive to a second external control signal provided thereto that is separate from the first external control signal;
providing a second current signal to the second signature identification circuit via the address signal; and
providing a second voltage signal across the second signature identification circuit responsive to the second external control signal and the second current based on states associated with second fuses indicating information programmed into the first signature identification.

20. A method according to claim 19 wherein enabling a second signature identification circuit further comprises enabling the second signature identification circuit responsive to the second external control signal at a time when the first external control signal disables operation of the first signature identification circuit.

21. A computer program product comprising a computer readable medium having computer readable program code embodied therein, the computer readable program code configured to operate according to the method of claim 19.
